(19) United States
(12) Patent Application Publication
(10) Pub. No.: US 2013/0156927 A1
(43) Pub. Date: Jun. 20, 2013

(54) SALAD COMPLIMENT COMPOSITION

(71) Applicant: David Soltysik, Kingsland, GA (US)

(72) Inventor: David Soltysik, Kingsland, GA (US)

(21) Appl. No.: 13/331,236

(22) Filed: Dec. 20, 2011

(51) Int. Cl. A23L 1/222; A23L 1/223; A23L 1/224

(52) U.S. Cl. 426/589

(57) ABSTRACT

The present invention is a salad compliment composition that includes 5 tablespoons of olive oil, ½ cup of original rice vinegar, ½ cup natural rice vinegar, 2 tablespoons of dried onions, 2 tablespoons of dried garlic and 2 tablespoons of oregano. The salad compliment composition can also include any quantity of original rice vinegar that is added to the salad compliment composition to suit a user's taste or any quantity of salt that is added to the salad compliment composition to suit a user's taste. The salad compliment composition can be used as a salad topping, a vegetable topping, a bell pepper topping, a tomato topping or a feta cheese topping. The salad compliment composition is stored in 12 ounce, 16 ounce or other suitably sized bottles or jars.

### TECHNICAL FIELD & BACKGROUND

Currently there are limited options for unconventional condiments. Individuals who enjoy food enhancing products, are constantly searching for new goods within the world of culinary arts.

It is an object of the invention to provide a salad compliment composition that serves as an alternative salad compliment.

It is an object of the invention to provide a salad compliment composition that provides a distinctive topping to be used and poured on vegetables.

What is really needed is a salad compliment composition that serves as an alternative salad compliment that provides a distinctive topping to be used and poured on traditional and other types of salads and vegetables.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

The composition of the present invention is a salad compliment composition. The salad compliment composition is a salad and vegetable topping to be utilized with traditional or other types of salads. Made from a rice vinegar base, that incorporates both natural and original fermentations, the salad compliant composition also blends olive oil, dried onions, garlic, oregano and optionally salt, offering a relatively desirable tasting, light bodied condiment that can highlight flavors in green salads, bell peppers, feta cheese, tomatoes and other salads and vegetables. Pre-packaged in standardized 12 oz., 16 oz. and other suitable size bottles or jars to preserve taste and consistency, the salad compliment composition can be used to expand the palate of various cuisines, dishes and foods. The salad compliment composition is created from a plurality of tastes from sweet or semi-sweet alternative dressings. The salad compliment composition is a relatively light yet favorable condiment that combines a relatively delightful blend of ingredients, to provide edible enjoyment.

### EXAMPLE

The salad compliment composition includes the following approximate quantity of ingredients:
4 tablespoons of olive oil;
½ cup of original rice vinegar (or a suitable quantity added to suit a user's desired taste.);
½ cup natural rice vinegar;
2 tablespoons of dried onions;
2 tablespoons of dried garlic;
2 tablespoons of oregano; and
an optional suitable quantity of salt quantity added to suit a user's desired taste.

The salad compliment composition does not require refrigeration but can be refrigerated to be served cold or stored in a refrigerator to be stored.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A salad compliment composition to provide edible enjoyment, consisting of:
4 tablespoons of olive oil;
½ cup of rice vinegar;
½ cup natural rice vinegar;
2 tablespoons of dried onions;
2 tablespoons of dried garlic;
2 tablespoons of oregano; and
salt, the olive oil, the rice vinegars, the dried onions, the dried garlic, the oregano and the salt blend to make the salad compliment composition, the salad compliment composition offers a light bodied condiment that highlight flavors in green salads, bell peppers, feta cheese and tomatoes and the salad compliment composition is pre-packaged in a selected one of a 12 ounce bottle or jar and a 16 ounce bottle or jar to preserve taste and consistency.

2.-10. (canceled)
